(19) United States
(12) Patent Application Publication
(10) Pub. No.: US 2004/0160387 A1
(43) Pub. Date: Aug. 19, 2004

(54) Cathode ray tube having an improved electron gun

(76) Inventors: Youn Jin Kim, Gumi-si (KR); Jae Ho Lee, Daegu-si (KR)

Correspondence Address: BIRCH STEWART KOLASCH & BIRCH, PO BOX 747, FALLS CHURCH, VA, 22040-0747, US

(21) Appl. No.: 10/750,874

(22) Filed: Jan. 5, 2004

(30) Foreign Application Priority Data
Feb. 14, 2003 (KR) 9321/2003

(51) Int. Cl. G09G 1/06

(52) U.S. Cl. 345/10

(57) ABSTRACT

A cathode ray tube has a low focus degradation, optimum focus characteristic and improved resolution by optimizing a relation between a horizontal inside diameter of a rim portion, which is a common opening portion of main lens forming electrodes for focusing electron beams onto a screen, and a horizontal distance between outside end of one outer electron beam passing hole to outside end of the other outer electron beam passing hole of a correction electrode.

### BACKGROUND OF THE INVENTION

1. Field of the Invention

The present invention relates to a cathode ray tube, more particularly, to a cathode ray tube with a low focus degradation, optimum focus characteristic and improved resolution by optimizing a relation between a horizontal inside diameter of a rim portion, which is a common opening portion of main lens forming electrodes for focusing electron beams onto a screen, and a horizontal distance between outside end of one outer electron beam passing hole to outside end of the other outer electron beam passing hole of a correction electrode.

2. Discussion of the Background Art

FIG. 1 illustrates the structure of a related art cathode ray tube.

As shown in the drawing, the cathode ray tube generally includes a fluorescent screen 1 coated with R, G and B fluorescent substances on inner surface thereof, a panel 3 coupled with a shadow mask 2 having a color selection function, and a funnel 4 connected to the panel 3, thereby forming an evacuated envelope together, a neck portion being formed in the funnel 4.

An electron gun 5 is housed inside the neck portion of the funnel 4, and a deflection yoke 6 for horizontally and vertically deflecting electron beams 8 emitted from an electron gun 5 is coupled to outside of the neck portion.

Also, a VM (Velocity Modulation) coil 7 to which a differential value of an image signal is applied is attached to the outside peripheral surface of the neck portion, in order to control or modulate deflection velocity of the electron beams 8.

The electron gun 5 is comprised of a triode section and a main lens. The triode section includes a cathode with a built-in heater, a control electrode and an accelerating electrode for controlling and accelerating thermal electrons emitted from the cathode, all arranged in in-line shape. The main lens includes a focus electrode and an anode electrode for focusing and eventually accelerating electron beams generated by the triode section. Meanwhile, a shield cup is attached to the anode electrode.

The built-in heater inside the cathode is connected to a power source through stem pins 5a, and a B.S.C (Bulbe Space Connector) 5b for fastening the electron gun 5 onto the neck portion is formed at an end of the shield cup.

When the heater inside of the cathode is connected to the power source through the stem pins 5a, electron beams (usually R, G and B electron beams) are emitted from the electron gun 5. These R, G and B electron beams 8 emitted from the electron gun are controlled, focused and accelerated by electrodes of the electron gun, and horizontally and vertically deflected by the deflection yoke 6. Then the deflected electron beams land on designated positions on the fluorescent screen 1, exciting each fluorescent substance, and subsequently a desired image is displayed.

More specifically, the electron beams 8 emitted from the electron gun 5 are deflected in horizontal and vertical directions by the deflection yoke 6, and those deflected electron beams 8 pass through electron beam passing holes formed on the shadow mask 2, and strike the fluorescent screen 1. As a result, a color image is displayed on the screen.

To improve resolution (i.e. image contrast), or in other words, to distinguish a bright region from a dark region on an image more clearly, some manufacturers applied to a dipolar coil a current in proportion to the differential value of an image signal, and tried to modulate deflection velocity of the electron beams by the deflection yoke 6 at the bright and dark regions of the image.

Underlying technical principle of the above method is that the VM coil 7 is arranged in the same direction with that of the horizontal deflection coil of the deflection yoke 6, and the dipolar coil of the VM coil 7 controls the instantaneous scan velocity of the electron beam 8, thereby improving the image contrast.

FIG. 2 is a diagram illustrating the structure of an in-line electron gun for use of a cathode ray tube. As shown in the drawing, a cathode 11 having a built-in heater 10 is arranged in an inline shape with respect to R, G and B, respectively, and a first electrode (G1 electrode) 12, a second electrode (G2 electrode) 13, a third electrode (G3 electrode) 14, a fourth electrode (G4 electrode) 15, a fifth electrode (G5 electrode) 16, and a sixth electrode (G6 electrode) 17, all being common grids of the cathode, are arranged in sequence. On the upper portion of the sixth electrode 17 is a shield cup 18 to which B.S.C 5b for electrically connecting the electron gun to the evacuated tube and thus, fastening the electron gun onto the neck portion.

An applied voltage Vg1 to the first electrode 12 is generally an earth voltage, an applied voltage Vg2 to the second electrode 13 ranges from 400V to 1 kV, and an applied voltage for focusing is in a range of 20 kV to 30 kV.

Inside of the fifth electrode 16 and the sixth electrode 17 is a common opening portion through which three electron beams pass, and electrostatic field control electrodes 161 and 171, namely inner correction electrodes, are respectively built in, being recessed by a predetermined depth (d) from the common opening portion. Another correction electrode 181 is also attached to the nearby shield cup 18 connected to the sixth electrode 17.

The fifth electrode 16 is designated as a focus electrode, and the sixth electrode is designated as an anode electrode.

For the electron gun with the above constitution, when the heater 10 built in the cathode 11 is connected to a power source through stem pins 5a, electrons are emitted from the surface of the cathode, and these electrons, electron beams 8 to be more specific, are controlled by the first electrode 12, which is a control electrode, and accelerated by the second electrode 13, which is an accelerating electrode. Then, part of the electron beams are focused and accelerated by a shear focus lens disposed between the second electrode 13 and the fifth electrode 16, but mainly the electron beams are focused and accelerated by the fifth and sixth electrodes 16 and 17 forming the main lens.

The electron beams are deflected by the deflection yoke in the horizontal and vertical directions, pass through a shadow mask 2, and strike a fluorescent screen 1 where fluorescent substances are illuminated, displaying an image on the screen.

FIG. 3 illustrates a related art triode lens, in which electron beam passing holes on a first electrode 12 and a second electrode 13 are disposed on the opposite sides from each other.

As shown in the drawing, the first electrode 12 has three electron beam passing holes 121, 122 and 123 for R, G and B electron beams, and these electron beam passing holes 121, 122 and 123 are formed on slots 124, 125 and 126 that are recessed into the electrode by a predetermined depth.

Each of the electron beam passing holes 121, 122 and 123 of the first electrode 12 is horizontally elongated, that is, a horizontal length (H) thereof is greater than a vertical length (V). Also, each of the slots 124, 125 and 126 that are recessed into the electrode by the predetermined depth is also horizontally elongated, that is, a horizontal length (Dh) thereof is greater than a vertical length (Dv).

Likewise, the second electrode 13 has three electron beam passing holes 131, 132 and 133 corresponding to R, G and B electron beams, and these electron beam passing holes 131, 132 and 133 are formed on slots 134, 135 and 136 that are recessed into the electrode by a predetermined depth. Each of the electron beam passing holes 131, 132 and 133 of the second electrode 13 is horizontally elongated, that is, a horizontal length (H) thereof is greater than a vertical length (V). Meanwhile, each of the slots 134, 135 and 136 that are recessed into the electrode by the predetermined depth is vertically elongated, that is, a horizontal length (Dh) thereof is less than a vertical length (Dv).

On the other hand, the electron beam passing holes of the third electrode 14 are all circular.

FIG. 4 depicts partially cut-out structures of electrodes forming a main lens in a related art electron gun.

As shown in FIG. 4, on opposite surfaces of the fifth and the sixth electrodes 16 and 17 forming a main lens, common opening portions for three electron beams, namely rim portions 162 and 172, are formed. Also, inner correction electrodes 161 and 171, which are electrostatic field control electrodes having vertically elongated electron beam passing holes 163, 164 and 165, and 173, 174 and 175, each having horizontal length (in-line direction) less than vertical length (in-line direction), are formed at places that are recessed into the electrode from the rim portions 162 and 172 by a predetermined depth.

A color cathode ray tube with an application of the in-line type electron gun having been discussed above employs a self-convergence deflection yoke using a non-uniform magnetic field, in order to converge each of R, G and B electron beams onto one spot on a fluorescent screen. This is because the R, G and B electron beams in the in-line type electron gun are arranged horizontallyin an in-line direction.

Particularly, the magnetic field generated by the self-convergence deflection yoke has a pin-cushioned shape for a horizontal deflection magnetic field, and a barrel shape for a vertical deflection magnetic field, whereby a mis-convergence problem around the fluorescent screen can be corrected.

A quadruple element of the deflection magnetic field focuses electron beams in a vertical direction, while diverges electron beams in a horizontal direction. Therefore, electron beams in the vertical direction, compared to electron beams in the horizontal direction, are more focused on the screen from a shorter distance. As a result, the vertical direction of the electron beams is convexed or raised on the screen (this phenomenon is called a ‘halo’ phenomenon), causing deteriorations in picture quality.

That is, because a deflection magnetic field is not applied to the central portion of the screen, an electron beam spot has a clear shape at the central portion of the screen. However, as the electron beams are diverged in the horizontal direction and overly focused in the vertical direction, a halo, which is a horizontally elongated core having a distorted high-density and a blurred image having a low density at upper and lower sides of the core, is generated, and this particularly worsens the resolution at the peripheral portion of the screen.

Therefore, if the deflection yoke generates a non-uniform magnetic field, it is rather natural to see distortions in a beam spot on the peripheral portion of the screen.

The above problem gets worse as a cathode ray tube is large, or deflection angle is increased. Considering that consumers prefer large-scale cathode ray tubes nowadays, and that deflection angle is increased in proportional to the size of a (picture) tube, there is no question about the necessity to solve distortions in a beam spot.

One way to solve the above problem is generate a quadrupole element from the electron gun to cancel a quadrupole element generated from the self-convergence type deflection yoke. In this manner, both horizontal and vertical electron beams can be focused onto one spot at the same time.

That is to say, to form a quadrupole lens, a focus electrode can be split into two focus electrodes, such as, a first focus electrode and a second focus electrode, and then a dynamic quadrupole electrode is disposed between the first and second focus electrodes to generate a potential difference at the quadrupole electrode. With this quadrupole lens, astigmatism can be compensated.

Nevertheless, the above is not enough to completely get rid of a halo phenomenon because electron beam traveling distances are different for the central portion and for the peripheral portion of the screen. For example, electron beams in the peripheral portion of the screen are usually focused in front of the screen, not on the screen.

To improve the above problem, manufacturers apply a dynamic voltage (variable voltage) synchronous with a deflection frequency when an electron beam is deflected to the peripheral portion of the screen. In so doing, a main lens' power is weakened so that one can adjust the focusing distance of a beam and thus, compensate astigmatism.

Another recently developed method for improving the resolution of a screen is to reinforce contrast at the edge of an image with the application of the aforementioned VM coil 7, a coil magnetic field-sensitive electron gun, and a chassis circuit.

Particularly, the VM coil 7 is effective for reducing a horizontal spot size of an image with a repeating edge because it works in a horizontal direction of electron beams.

To be short, many traditional methods for reducing spot size are closely associated with the reduction of the size of an electron beam passing hole 121, 122 or 123 of the first electrode 12 (refer to FIG. 3). Although people assumed that the beam size would be naturally reduced as they reduce the size of an electron beam passing hole, this method gave rise to the following disadvantages.

In case of a TV electron gun, for example, when more current is applied too the electron gun in order to increase brightness thereof, the repulsive force of a free space electron gets stronger, and as a result, it becomes more difficult to adjust a divergence angle of an electron beam and thus, to control the size of an electron beam. Moreover, as the size of an electron beam passing hole is reduced, a spot blanking voltage is also lowered, thereby deteriorating beam drive characteristics. In consequence, it becomes so hard to increase current density and brightness that focus characteristics get worse.

When it comes to a high-current cathode ray tube for use of TVs, the spot size in the horizontal direction is relatively easier to reduce than the spot size in the vertical direction. This is because of the influence of the aforementioned VM coil 7 and improved resolution.

Many times manufacturers use a traditional method for reducing the spot size in the vertical direction. In this traditional method, electron beam passing holes 121, 122 and 123 of a first electrode (G1) 12 are horizontally elongated by reducing the vertical size (V) thereof.

However, the reduction of the vertical size (V) of the electron beam passing holes 121, 122 and 123 of the first electrode (G1) 12 gives rise to a horizontally elongated hole of the first electrode (G1) 12, and this horizontally elongated hole (i.e. H>V) consequently causes discrepancies in a horizontal divergence angle and a vertical divergence angle. In general, if the vertical size is extremely reduced, as shown in FIG. 5, and thus, the electron beam passing holes are horizontally elongated much more than intended, the horizontal divergence angle in a triode section becomes relatively greater than the vertical divergence angle. Therefore, the originally expected result is not easily obtained.

In the meantime, an electron gun having an asymmetric large-aperture has the following problems.

For example, there are correction electrodes 161 and 171 inside the fifth electrode 16 and sixth electrode 17 having common electron beam passing holes, in order to control astigmatism of the electron beams. Particularly, shape of the correction electrode is very closely related to the S-value (Separation-value) of the electron gun, that is, the horizontal diameter of each of electron beam passing holes 163, 164, 165, 173, 174 and 175 of the correction electrodes cannot be greater than the S-value.

As for the first electrode 12, the second electrode 13 and the third electrode 14, the S-value indicates the distance between the center of a central electron beam passing hole and the center of an outside electron beam passing hole.

The horizontal effective lens diameter of the main lens of a central electron beam formed by the electron beam passing holes of the correction electrodes 161 and 171 disposed inside of the fifth and sixth electrodes 16 and 17 is relatively less than the horizontal effective lens diameter of the main lens of an outer electron beam formed by the outer shapes of the rim portions 162 and 172 of the fifth and sixth electrodes 16 and 17 and the correction electrodes 161 and 171.

Hence, although it could be possible to form an optimum electron beam spot on the screen, the spot size of the central electron beam is greater than the spot size of the outer electron beam.

In addition, since the central electron beam, which is a Green fluorescent substance, has a higher luminous efficiency than a Red or Blue fluorescent substance, it looks even bigger. Thus, relative deteriorations in focus of the central electron beam with respect to the outer electron beam get worse. This relative deterioration of the central electron beams subsequently deteriorates the resolution.

Also, if the horizontal diameter of the central electron beam passing hole is greater than the S-value to enlarge the horizontal effective lens diameter of the main lens of the central electron beam, the center of the horizontal effective lens diameter of the main lens of the outer electron beam formed by the outside shape of the correction electrode is deviated from the S-value, and the outer electron beam cannot transmit the center of the main lens diameter, passing though its peripheral portion instead.

In such case, electron beam focusing becomes bilaterally asymmetric, and one side (either left or right side) is haloed or bloomed, consequently causing a coma with deteriorated resolution.

### SUMMARY OF THE INVENTION

An object of the invention is to solve at least the above problems and/or disadvantages and to provide at least the advantages described hereinafter.

Accordingly, one object of the present invention is to solve the foregoing problems by providing a cathode ray tube with less deterioration in resolution because of an enlarged horizontal direction spot on a screen and with improved focus characteristics, by increasing a diameter of an effective main lens of an electron gun.

Another object of the present invention is to provide a cathode ray tube with improved resolution and focus characteristics by horizontally elongating an electron beam passing hole of a control electrode to reduce a vertical spot size of an electron beam on a screen, and inhibiting a divergence angle in a horizontal direction from increasing by increasing the effective lens diameter.

Another object of the invention is to provide an electron gun for a cathode ray tube with improved focus characteristics and resolution by properly optimizing a relation between a horizontal inside diameter (Dr) of a rim portion, which is a common opening portion for forming an opposite surface of a focus electrode and an anode electrode for forming a main lens of the electron gun, and a horizontal distance (Di) between outside end of one outer electron beam passing hole to outside end of the other outer electron beam passing hole of a correction electrode formed inside of the main lens.

The foregoing and other objects and advantages are realized by providing a cathode ray tube comprising: a panel having a fluorescent formed on an inner surface thereof; a funnel connected to the panel; an electron gun housed in the funnel, emitting electron beams; a deflection yoke for deflecting the electron beams in horizontal and vertical directions; and a shadow mask for selecting colors of the electron beams, wherein the electron gun is comprised of a cathode for emitting electron beams, a first electrode for controlling an emission amount of the electron beams, a second electrode for accelerating the electron beams, at least two electrodes for forming a pre-focus lens, focusing a designated amount of the electron beams, and at least two main lens forming electrodes for forming a main lens, focusing the electron beams onto a screen, and a horizontal inside diameter (Dr) of an opening portion of one of the main lens forming electrodes and a horizontal distance (Di) between outside end of one outer electron beam passing hole to outside end of the other outer electron beam passing hole of a correction electrode mounted with three electron beam passing holes on an inside thereof satisfy a relation of 0.97≦Di/Dr≦1.03.

A horizontal size (Sx) of the outer electron beam passing hole of the correction electrode formed on at least one of the main lens forming electrodes, and a horizontal size (Cx) of a central electron beam passing hole satisfy a relation of 0.6≦CX/Sx≦0.75.

Di/Dr of one of the main lens forming electrodes, being opposite to an electrode to which an anode voltage is applied, is greater than Di/Dr of the electrode to which the anode voltage is applied.

Cx/Sx of one of the main lens forming electrodes, being opposite to an electrode to which an anode voltage is applied, is less than Cx/Sx of the electrode to which the anode voltage is applied.

Sx of the correction electrode formed on at least one of the main lens forming electrodes is 6.8 mm and less.

A horizontal size of an electron beam passing hole on the first electrode is equal to or greater than a vertical size of the same.

Horizontally elongated electron beam passing holes or horizontally elongated slots are formed on the second electrode.

A depth (d) from an opening portion to a correction electrode of at least one of the main lens forming electrodes is in a range of 3.2-4.2 mm.

A depth (d) from an opening portion to a correction electrode of an electrode to which an anode voltage is applied is greater than a depth (d) from an opening portion to a correction electrode of an opposite electrode.

An outer surface of the panel is substantially flat, and an inner surface of the panel has a designated curvature.

Lastly, a shape of a yoke mounting portion of the funnel on which the deflection yoke is mounted gradually changes from a circular shape to a non-circular shape from a neck side of the funnel to the panel side direction.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of a related art cathode ray tube;

FIG. 2 illustrates the structure of an in-line electron gun used in a related art cathode ray tube;

FIG. 3 illustrates a first electrode and a second electrode for forming a triode portion lens according to a related art, wherein electron beam passing holes formed on each electrode are opposite with each other;

FIG. 4 illustrates structures of electrodes for forming a main lens of a related art electron gun;

FIG. 5 graphically illustrates a relation between horizontal and vertical sizes of an electron beam passing hole formed on a first electrode and a divergence angle;

FIG. 6 is a front view of an electrode for forming a main lens according to the present invention;

FIG. 7 graphically illustrates primary factors that determine a spot size of an electron beam;

FIG. 8 depicts an occurrence of a coma phenomenon;

FIG. 9 graphically illustrates how coma relates to a separation (Dbt in FIG. 6) between a center of a central electron beam passing hole and a center of an outer electron beam passing hole, given that S=5.5; and

FIG. 10 graphically illustrates a relation between a spot size and a ratio of a horizontal size of a central electron beam passing hole to a horizontal size of an outer electron beam passing hole.

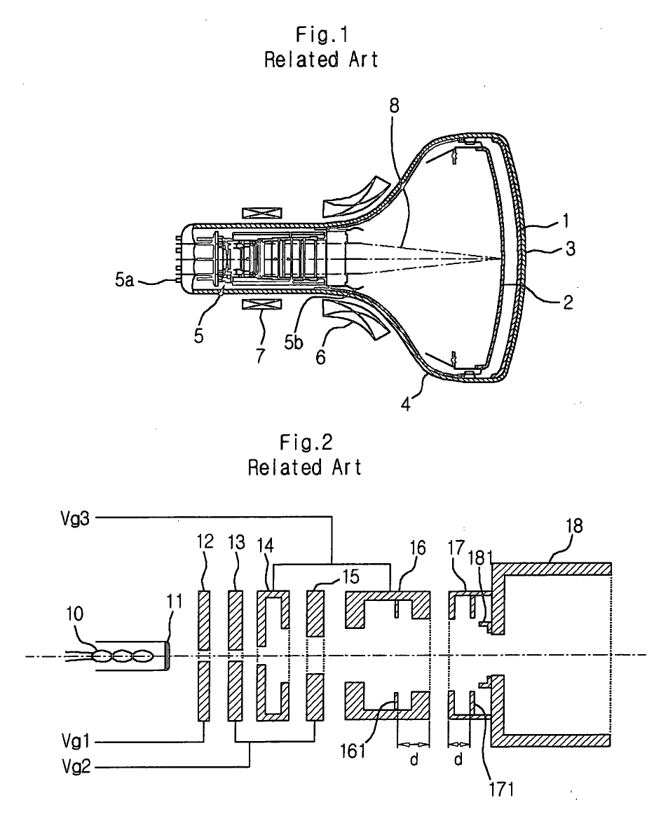

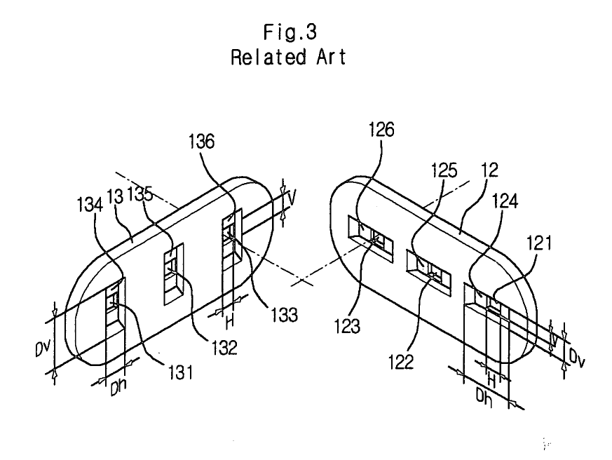

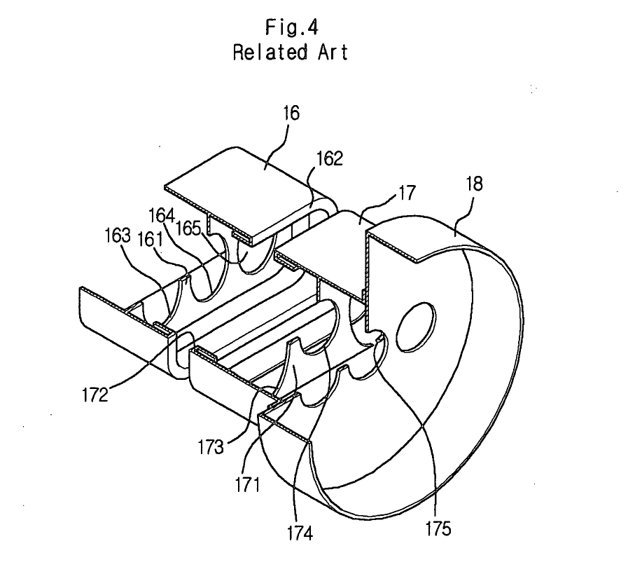

### DETAILED DESCRIPTION OF PREFERRED EMBODIMENTS

The following detailed description will present a cathode ray tube according to a preferred embodiment of the invention in reference to the accompanying drawings.

The cathode ray tube of the invention includes a panel having a fluorescent screen formed on an inner surface thereof, a funnel connected to the panel, an electron gun for emitting electron beams, a deflection yoke for deflecting the electron beams in horizontal and vertical directions, and a shadow mask with a color selecting function of the electron beams.

Preferably, an outer surface of the panel is substantially flat, and an inner surface thereof has a designated curvature. Also, the funnel has a yoke mounting portion on which the deflection yoke is mounted, and the shape of the yoke mounting portion gradually changes from a circular shape to a non-circular shape in a direction from a neck side to the panel side.

In this type of cathode ray tube, electrodes of an in-line electron gun are positioned at regular intervals, being at right angles to a traveling path of electron beams, in order to control the electron beams generated by a cathode to a predetermined intensity and then help them arrive at a screen.

More specifically, there are three mutually-independent cathodes, a first electrode (G1 electrode), which is a common grid of another three cathodes standing apart from the first three cathodes by a predetermined distance, a second electrode (G2 electrode), a third electrode (G3 electrode), a fourth electrode (G4 electrode), a fifth electrode (G5 electrode) and a sixth electrode (G6 electrode), the second through sixth electrodes being arranged at regular intervals from the first electrode. Also, on the upper portion of the sixth electrode (G6 electrode) is a shield cup mounted with B.S.C for electrically connecting the electron gun to the cathode ray tube and fastening the electron gun onto the neck portion of the cathode ray tube.

To see how the electron gun works, when a heater built in the cathode is connected to a power source through stem pins, electron beams are emitted from the surface of the cathode, and these electron beams are controlled by the first electrode (G1), which is the control electrode, and accelerated by the second electrode (G2), which is the accelerating electrode. Part of the electron beams is focused/accelerated by a shear focus lens formed among the second electrode (G2), the third electrode (G3), the fourth electrode (G4) and the fifth electrode (G5), but mainly the electron beams are focused/accelerated by the fifth electrode (G5), which is the focus electrode, and the sixth electrode (G6), which is the anode electrode, forming the main lens together. Afterwards, the electron beams pass through the shadow mask and strike the fluorescent screen, emitting a light.

Especially, in case that the control electrode (G1) has horizontally elongated electron beam passing holes, that is, a horizontal direction size (H) of the electron beam passing hole is greater than a vertical direction size (V), a divergence angle in the horizontal direction is increased, and the electron beam's incident diameter on the main lens is also increased, which resultantly invites a heavy influence of spherical aberration of the main lens. To minimize the influence of spherical aberration, therefore, the effective lens diameter of the main lens should be increased, and instrumental scales for the main lens forming electrodes should be established.

Referring to FIG. 4, an opposite surface of each electrode 16 and 17 for forming a large-diameter main lens has a rim portion 162 and 172, which is a common opening portion through which each electron beam pass, and inside of the respective main lens forming electrodes 16 and 17 is an inner correction electrode 161 or 171 having electron beam passing holes 163, 164 and 165 or 173, 174 and 175, respectively.

In the present invention, at least one of the opposite electrodes 16 and 17 for forming the main lens has a depth (d), a distance from the rim portion 162 or 172 forming the common opening portion to the correction electrode, in a range of 3.2 mm to 4.2 mm. More preferably, the depth (d) from the rim portion 172, which is the common opening portion, to the recessed correction electrode 171 of the electrode 17 to which an anode voltage is applied is greater than the depth (d) from another rim portion 162, which is the common opening portion, to the recessed correction electrode 161 of the electrode 16.

Moreover, in case of an electron gun having a triode portion generating electron beams with a large horizontal direction divergence angle, an inside horizontal size (Dr) of the respective rim portions 162 and 172, and a horizontal distance Pi) between outside end of one outer electron beam passing hole to outside end of the other outer electron beam passing holes 163 and 165/173 and 175 of the inner correction electrodes 161 and 171 are restricted in particular ranges.

The problem with a traditional main lens was that an effective lens diameter of the main lens of a central electron beam was smaller than an effective lens diameter of the main lens of an outer electron beam. Therefore, in order to enlarge an electron beam passing hole formed on the respective main lens forming electrodes, there is a need to make the effective lens diameter of the main lens of the central electron beam close to the effective lens diameter of the main lens of an outer electron beam. In other words, instrumental scales of outer electron beam passing holes 163, 165, 173 and 175, namely a ratio of a horizontal size (Cx) of each of the central electron beam passing holes 164 and 174 to a horizontal size (Sx) of each of the outer electron beams 163, 165, 173 and 175 should be restricted in particular ranges of values.

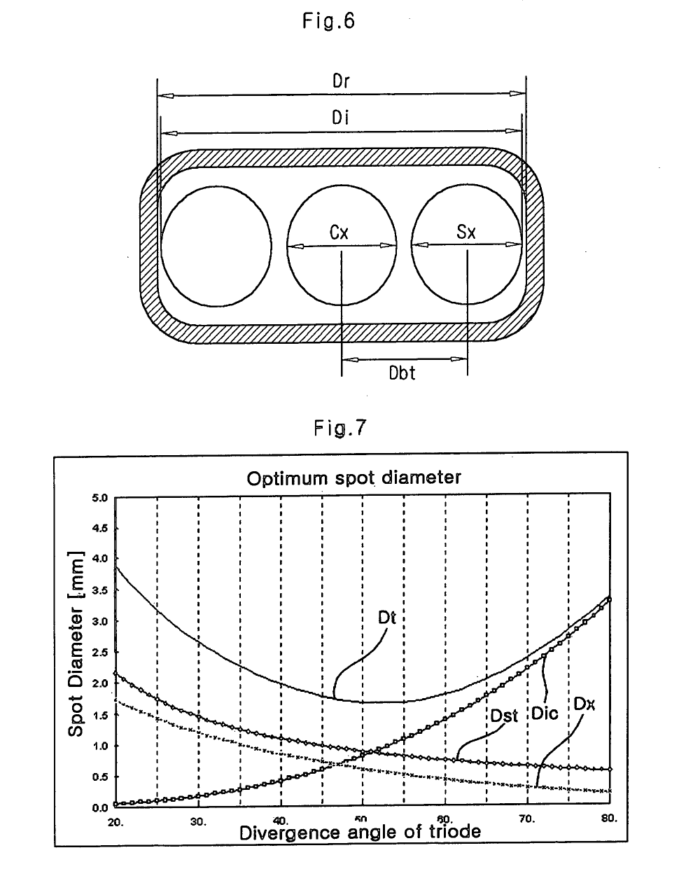

Particularly for the present invention, the ratio of Di to Dr, i.e. Di/Dr, is set to be in a range of 0.97<Di/Dr<1.03, as shown in FIG. 6. This is somewhat different from most related art electron guns of which Di/Dr satisfies a condition of 0.89<Di/Dr<0.92.

Further, Cx and Sx are set to be able to satisfy a condition of 0.6<Cx/Sx<0.75. According to the several experiments being conducted, optimum focus characteristics are obtained when the above conditions are met.

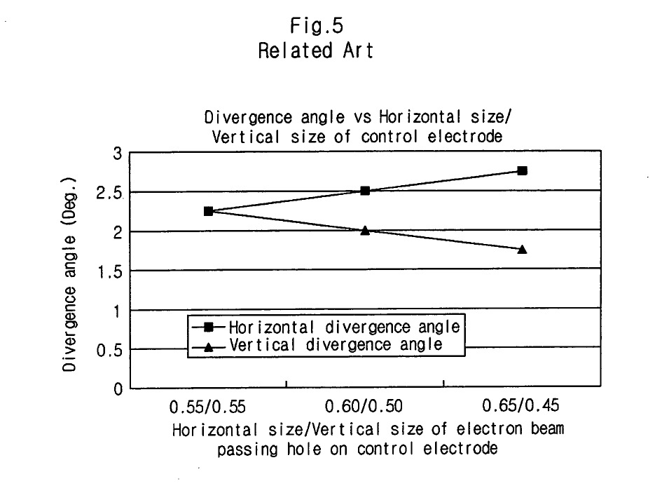

As discussed before, FIG. 5 is a graph illustrating a relation between horizontal direction sizes (H) and vertical direction sizes (V of respective electron beam passing holes formed on the first electrode 12, which is the control electrode. As shown on the graph, as H/V increases, a divergence angle of an electron beam in the horizontal direction increases but a divergence angle of an electron beam in the vertical direction decreases.

In short, the electron beam's divergence angle in the horizontal direction increases if the horizontal size (H) of each of the electron beam passing holes 121, 122 and 123 of the first electrode 12 is relatively larger than the vertical size (V) thereof. In such case, the divergence angle in the vertical direction is gradually decreased.

However, if the ratio of the horizontal size (H) to the vertical size (V) goes beyond a certain point, the horizontal divergence angle is increased, and thus a horizontal diameter of an electron beam incident upon the main lens is also increased equal to or grater than an outer point of the horizontal diameter of the effective main lens formed by the main lens forming electrodes 16 and 17. As a result, the influence of the spherical aberration of the main lens gets stronger, and a spot size on the screen is increased, and the resolution is also deadly deteriorated thereby.

FIG. 7 elaborates on the above.

When it comes to design characteristics of an electron gun, there are some criteria that influence the spot size (Dt) on an image screen, such as lens magnification, space charge repulsive force and a main lens spherical aberration. Among others, the influence of the lens magnification on the spot size (Dx) of the electron beams is defined by a basic voltage condition, a focus distance, a length of the electron gun, and the like, so it is of little use, and has very little significance as a design parameter of the electron gun.

The spatial charge repulsive force is a phenomenon in which the spot diameter of the electron beams are enlarged as the electrons in the electron beams repulse and collide to one another. Therefore, for reducing enlargement of the spot size (Dst) of the electron beams caused by the spatial charge repulsive force, it is favorable that a traveling angle of the electron beams (called “a diverging angle”) is designed to be great.

On the contrary, the spherical aberration of the main lens, a characteristic representing an enlargement of the spot diameter (Dic) caused by a difference of focal distances of electrons passed through a radical axis and passed through a protaxis, forms the smaller spot diameter on the screen as the divergence angle of electron beams incident on the main lens is the smaller. In general, the spot size (Dt) on the screen can be expressed by using the following three parameters, Dx, Dst and Dic.

That is, Dₜ=\sqrt{(Dₓ+Dₛₜ)²+D_{ic}²}.

Particularly, the best method for reducing the spherical aberration together with a reduction of the space charge repelling force is increasing the diameter of the main lens. In doing so, even though an electron beam with a large divergence angle might be incident, the spot size will be hardly increased owing to the spherical aberration, and the space charge repelling force after the electron beam passes through the main lens can be reduced, thereby forming a small spot on the screen.

Therefore, the ratio of the horizontal size to the vertical size of the electron beam passing hole of the first electrode (G1 electrode) should be properly set. Preferably, the horizontal size is equal to/greater than the vertical size.

Also, if possible, the ratio of the horizontal size to the vertical size of the electron beam passing hole of the second electrode (G2 electrode) should be properly set. As an exemplary embodiment, the electron beam passing holes of the second electrode are horizontally elongated, or horizontally elongated slots are formed.

Despite the instrumental transformation of the accelerating electrode, there are limitations in the reduction of the enlargement of a horizontal divergence angle at the control electrode (G1) where the ratio of the horizontal size to the vertical size of the electron beam passing hole is small. To make it possible, the effective lens diameter of the main lens should be increased.

However, to increase the effective lens diameter of the main lens, it is necessary to take instrumental scales of main lens forming electrodes into consideration. Unfortunately though, it is impossible to increase the effective lens diameter of the main lens without limits, and in any case, the lenses on the left and right sides of the respective outer electron beams should have equal diameters with each other.

If the above conditions are not met, a voltage value for a left side electron beam to focus on the screen is different from a voltage value for a right side electron beam to focus on the screen. This phenomenon resultantly causes a high coma value, giving the deadly influence on the resolution.

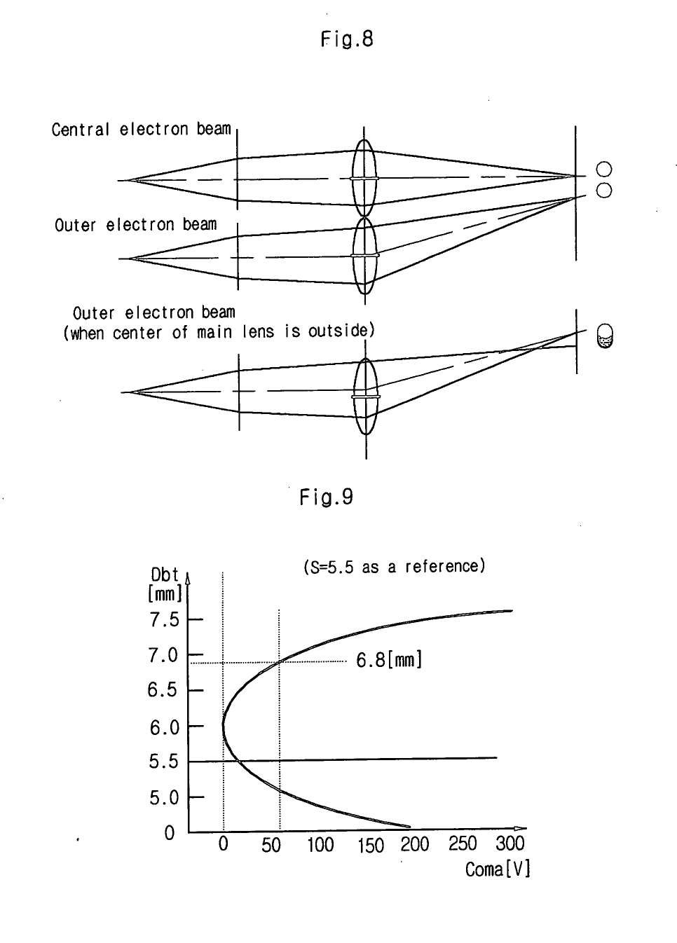

FIG. 8 illustrates an occurrence of a coma phenomenon, in which the center of a main lens and the center of an electron beam bundle crossed each other. This phenomenon causes a one-direction halo at a screen spot.

FIG. 9 illustrates a relation between a coma and a separation (Dbt in FIG. 6) between the center of a central electron beam passing hole and an outer electron beam passing hole, having S=5.5 as a reference.

Here, ‘Dbt’ denotes a separation between the center of an outer electron beam passing hole 165 or 175 of an inner correction electrode 161 or 171 of the main lens forming electrodes 16 and 17 and the center of a central electron beam passing hole 164 or 174.

In case of converting a coma value to a voltage, given that the coma value is regarded to be applicable if it is in a range of 100[V], the center of an electron beam bundle can be shifted by adjusting a S-value (Separation-value) between electron beam passing holes on the second electrode or the third electrode of the triode portion. However, the Dbt should be in a lower range than 6.8 mm or 6.8 mm since it might cause a serious problem otherwise.

As shown in FIG. 6, the above explains how the instrumental scale of the inner correction electrode of the main lens forming electrodes should be ranged. That is, the distance (Di) between outside end of one outer electron beam passing hole to outside end of the other outer electron beam passing hole of the inner correction electrode is greater than the inside horizontal size (Dr) of the rim portion, which is a common opening portion, formed on an opposite surface of the main lens forming electrodes.

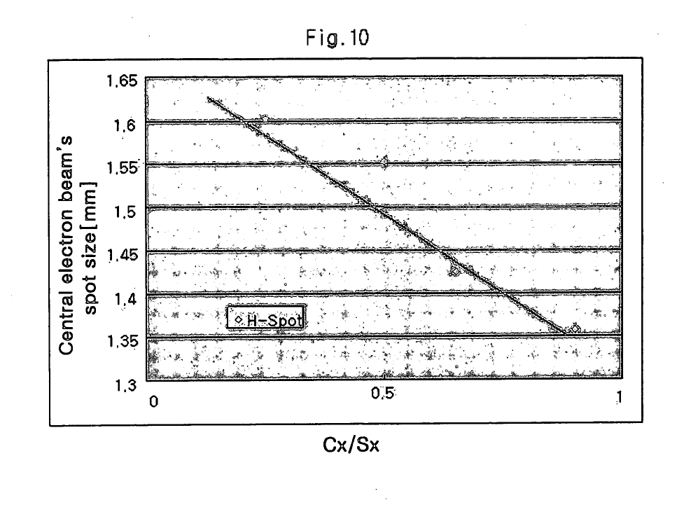

As depicted in FIG. 10, the spot size is dependent on the horizontal size (Sx) of the outer electron beam passing hole. From the graph, it is known that the horizontal direction spot size on the screen is in inverse proportion to the horizontal size (Sx). However, when the S-value becomes greater than 6.8 mm, the effective lens diameter of the main lens formed by the central electron beam passing hole gets considerably smaller than the effective lens diameter of the main lens of the outer electron beam, breaking the balance between the outer electron beam and the central electron beam and deteriorating the resolution. Hence, the S-value is preferably in a range of 6.0-6.4 mm.

At this time, the ratio of the horizontal size (Cx) of the central electron beam passing hole to the horizontal size (Sx) of the outer electron beam passing hole, i.e. Cx/Sx, is in a range of 0.6-0.75. Preferably, out of other opposite (or facing) electrodes for forming the main lens, the Cx/Sx of an electrode opposite to an electrode to which an anode voltage is applied is less than the Cx/Sx of an electrode to which the anode voltage is applied.

In such case, the inside horizontal size (Dr) of the rim portion which is the common opening portion on the opposite surface of the main lens forming electrodes, and the horizontal size (Di) between outside end of one outer electron beam passing hole to outside end of the other outer electron beam passing hole of the inner correction electrode should be restricted in a particular range as follows.

The separation between the center of the central electron beam passing hole and the center of the outer electron beam passing hole is 6.9 mm and less, and the horizontal size (Sx) of the outer electron beam passing hole is in a range of 6.0-6.8 mm, and an optimized condition in these ranges satisfies a relation of 0.97<Di/Dr<1.03.

Also, out of opposite electrodes forming the main lens, Di/Dr of the electrode opposite to the electrode to which the anode voltage is applied is greater than the Di/Dr of the electrode to which the anode voltage is applied.

As discussed so far, although an electron beam having a large divergence angle might be incident, it is possible to deter the spot size from increasing owing to the spherical aberration of the main lens by increasing the diameter of the main lens.

FIG. 10 also shows the relation between the spot diameter of the central electron beam and the main lens diameter. As one can see from the graph, as the main lens diameter of the central electron beam passing hole is increased, the enlargement of the spot diameter due to the spherical aberration of the main lens does rarely occurs, consequently reducing the spot diameter of an image on the screen.

As cathode ray tubes become large and have higher resolutions, there are certain conditions to be met in order to keep abreast with such trends. For example, the present invention introduced a horizontally elongated electron beam passing hole on the control electrode, thereby reducing the vertical size of a spot on the screen. Although this method increased a divergence angle in the horizontal direction, the problem can be corrected by enlarging the effective lens diameter of the main lens.

Moreover, deteriorations in the resolution because of the enlargement of a horizontal direction spot of the central electron beam can be prevented, and thus, focus characteristics can be improved.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A cathode ray tube comprising: a panel having a fluorescent formed on an inner surface thereof; a funnel connected to the panel; an electron gun housed in the funnel, emitting electron beams; a deflection yoke for deflecting the electron beams in horizontal and vertical directions; and a shadow mask for selecting colors of the electron beams, wherein the electron gun is comprised of a cathode for emitting electron beams, a first electrode for controlling an emission amount of the electron beams, a second electrode for accelerating the electron beams, at least two electrodes for forming a pre-focus lens, focusing a designated amount of the electron beams, and at least two main lens forming electrodes for forming a main lens, focusing the electron beams onto a screen, and a horizontal inside diameter (Dr) of an opening portion of one of the main lens forming electrodes and a horizontal distance (Di) between outside end of one outer electron beam passing hole to outside end of the other outer electron beam passing hole of a correction electrode mounted with three electron beam passing holes on an inside thereof satisfy a relation of 0.97≦Di/Dr≦1.03.

2. The cathode ray tube according to claim 1, wherein a horizontal size (Sx) of the outer electron beam passing hole and a horizontal size (Cx) of a central electron beam passing hole of the correction electrode formed on at least one of the main lens forming electrodes satisfy a relation of 0.6≦Cx/Sx≦0.75.

3. The cathode ray tube according to claim 1, wherein Di/Dr of one of the main lens forming electrodes, being opposite to an electrode to which an anode voltage is applied, is greater than Di/Dr of the electrode to which the anode voltage is applied.

4. The cathode ray tube according to claim 2, wherein Cx/Sx of one of the main lens forming electrodes, being opposite to an electrode to which an anode voltage is applied, is less than Cx/Sx of the electrode to which the anode voltage is applied.

5. The cathode ray tube according to claim 4, wherein Sx of the correction electrode formed on at least one of the main lens forming electrodes is 6.8 mm and less.

6. The cathode ray tube according to claim 1, wherein a horizontal size of an electron beam passing hole on the first electrode is equal to or greater than a vertical size of the same.

7. The cathode ray tube according to claim 6, wherein horizontally elongated electron beam passing holes or horizontally elongated slots are formed on the second electrode.

8. The cathode ray tube according to claim 1, wherein a depth (d) from an opening portion to a correction electrode of at least one of the main lens forming electrodes is in a range of 3.2-4.2 mm.

9. The cathode ray tube according to claim 8, wherein a depth (d) from an opening portion to a correction electrode of an electrode to which an anode voltage is applied is greater than a depth (d) from an opening portion to a correction electrode of an opposite electrode.

10. The cathode ray tube according to claim 1, wherein an outer surface of the panel is substantially flat, and an inner surface of the panel has a designated curvature.

11. The cathode ray tube according to claim 1, wherein a shape of a yoke mounting portion of the funnel on which the deflection yoke is mounted gradually changes from a circular shape to a non-circular shape from a neck side of the funnel to the panel side direction.

12. The cathode ray tube according to claim 1, wherein horizontally elongated electron beam passing holes or horizontally elongated slots are formed on the second electrode.
